(19) United States
(12) Patent Application Publication
(10) Pub. No.: US 2006/0045312 A1
(43) Pub. Date: Mar. 2, 2006

(54) Image comparison device for providing real-time feedback

(76) Inventors: Daniel Brooks Bernstein, San Jose, CA (US); Barry Lee Petersen, Castle Rock, CO (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/213,293

(22) Filed: Aug. 26, 2005

Related U.S. Application Data
(60) Provisional application No. 60/605,016, filed on Aug. 27, 2004.

(51) Int. Cl. G06K 9/00; G06K 9/62

(52) U.S. Cl. 382/103; 382/209

(57) ABSTRACT

A method and device for comparing a position template which is stored in a positional memory to a test image are presented. The method includes obtaining one or more images, defining the position template using the one or more images, training the position template(s) into a positional memory, obtaining the test image, and comparing the test image with the position template via the positional memory. Based on the comparison, a feedback is provided real-time. The feedback may include information about how to adjust the test image to better match the positional memory. The method and device have various applications that involve duplicating a previous position, confirming that a sequence of steps is properly performed, assessing object movements over time, etc. The sensitivity level of the device is adjustable depending on how exactly the user wants the positional memory and the test image to match.

### RELATED APPLICATION

This invention claims the benefit, under 35 USC §119(e), of U.S. Provisional Application Ser. No. 60/605,016 filed on Aug. 27, 2004, the content of which is incorporated by reference herein.

### FIELD OF INVENTION

This invention relates generally to a method and device for comparing data, such as data for images and/or sounds, and particularly to such method and device for providing real-time feedback to a user.

### BACKGROUND

There are many situations when it is desirable to duplicate or reproduce a certain position or movement. One such situation is where an artist is painting a human model. When painting, it is desirable for the model to be in the same position until the painting is completed. However, it is rarely the case that the human model can hold the same position for a long time, and almost impossible for the model to get into the same position after taking a break. The fact that the model cannot get into the same position after a break is a large challenging factor to the artist who is producing a quality painting.

Another example of such situation is in athletic activities such as golfing. Many golfers suffer frustration because they cannot duplicate the perfect swing they made on the previous hole or the previous day. One of the factors causing the frustration is not knowing what they are doing differently this time, or not being able to directly compare the current swing with their perfect swing.

Still another example of such a situation is in therapeutic activities designed to relieve pain or enhance physical or mental well-being. Many people who work with computers all day suffer from back pain associated with bad posture. While computer users theoretically may know what good posture is, since they can not see themselves, they have trouble maintaining proper posture throughout the workday. Similarly, patients oftentimes meet with physical therapists to perform exercises to strengthen the body. When these patients practice the exercises at home, they do not know if they are doing them correctly because the trained physical therapist is not watching them.

Yet another example involves movements or positions based not on visual data but on temperature data, or other data sources. For example, in a dark environment, there may be times when heat-emitting objects need to be positioned in a certain way or in a certain location. However, since it is dark in the environment, it is difficult to see where to position the objects.

A device that allows a direct comparison of two positions or movements would be helpful in situations such as those described above. Such a device would provide beneficial real-time feedback to the users, who will then know what the difference is between the current position and the last or ideal position and become more likely to make proper adjustments.

### SUMMARY

In one aspect, the invention is a method of comparing a positional memory to a test image. The method entails obtaining training images of a target in one or more positions, and assigning the training images to a position template, generating a positional memory that takes into account variations among the training images that are assigned to the position template. A test image of the target is obtained with the target in a current position. The test image is compared against the positional memory to generate a comparison result, and a feedback is provided regarding the comparison result while the target is substantially in the current position.

In another aspect, the invention is a device for comparing a positional memory to a test image. The device includes an imaging device, a processor, and a user interface unit. The imaging device obtains training images of a target in one or more positions and a test image of the target in a current position. The processor assigns the training images to a position template, generates a positional memory that takes into account variations among the training images that are assigned to the position template, and compares one of the test images against the positional memory to generate a comparison result. The user interface unit provides a feedback regarding the comparison result while the target is substantially in the current position.

In yet another aspect, the invention is a computer-readable medium having computer executable instructions thereon for the method that is described above.

### BRIEF DESCRIPTION OF THE DRAWINGS

FIG. 1 is a block diagram of the position-comparing device in accordance with the invention.

FIG. 2 is a schematic view of an exemplary user interface used in the device of FIG. 1.

FIG. 3 is a flow chart depicting a mode selection process in accordance with the method of the invention.

FIG. 4 is a flow chart depicting a training process in accordance with the method of the invention.

FIG. 5 is a flow chart depicting a testing process in accordance with the method of the invention.

FIG. 6A is an exemplary embodiment of the invention.

FIG. 6B is another exemplary embodiment of the invention.

### DETAILED DESCRIPTION OF THE EMBODIMENT(S)

Embodiments of the invention are described herein in the context of images, and particularly in the context of images of a dynamic, rather than a stationary, object or target. However, it is to be understood that the embodiments provided herein are just preferred embodiments, and the scope of the invention is not limited to the applications or the embodiments disclosed herein. For example, the concept of the invention may be applied to comparison of position/movement based on auditory information, temperature information, etc. as well as visual information.

The invention presents a convenient, non-invasive method for comparing spatial positions of target objects and a device for executing this method. The method is non-invasive in the sense that it does not require any sensors or probes to be worn by the target, allowing the target to move or position his/her/itself naturally for accurate position comparison. The comparison may be done in a two- or three-dimensional perspective. Regardless of exactly how the comparison is done, the comparison and the feedback processes are executed in real time. The method entails capturing one or more training images, storing them in a “training database,” associating the training image(s) with a “position template” that has a specific “position template name” associated with it, producing a “positional memory” from the position template and position template name data, comparing subsequent test images against the positional memory, and providing the user with real-time feedback concerning how closely the test images match the position template data that is stored directly or abstractly in the positional memory. A positional memory takes into account the variations in all the training images that are assigned to the particular position template. The positional memory can simultaneously hold multiple position templates, each of which has a position template name. The exact method in which the positional memory stores these templates and template names depends on the associative model chosen for the particular embodiment. Associative models are discussed below.

A similarity threshold and an optional adjustable sensitivity level parameter are associated with each position template, so that a user can control how closely images have to be in agreement to be considered a “match.” A visual, auditory, or other signal may be triggered when there is a match. Multiple positions may be stored in the device of the invention. The invention provides a much-needed improvement in speed and ease of use for positional recognition and/or motion detection methods. It is also general in nature, and can be adapted successfully to any number of location/movement applications.

A “target” is intended to mean an object whose position or movement is being tested by the device of the invention. An “image” is intended to mean any recordable information regarding a position, movement, or activity including but not limited to visual, auditory, and other types of radiated information. The recordable information may be a still as in a picture or streaming, as in a video feed. A “camera” may be any sensor device that generates images or image data including but not limited to a digital camera, a video camera, microphone, thermal sensor, etc. A “position template,” as used herein, is a record of a specific single position, a specific set of positions, or a specific sequence of positions. A position template consists of a training image or set of training images of the target in a specific single position, a specific set of positions, or a specific sequence of positions. Closely associated with a position template is a “position template name.” A “position template name” as used herein, is a name or value preliminarily associated with a position template. Training images from one or more positions, one or more set of positions, or one or more sequences of positions may be assigned to the same position template if desired but each position template has only one position template name associated with it. A position template in its simplest form can be described as being the image of the desired or required position and may be thought of as an average image formed from a single image or multiple training images of the target in substantially similar positions.

A “training database” is a storage device for the training images that define a position template as well as a position template name that is associated with a position template. The data stored in the training database represent a preliminary set of relationships between training images and position template names. These data are used to construct or “train” the positional memory. These data and relationships can be modified prior to the creation of the positional memory if desired.

A “positional memory,” as used herein, is the record of one or more position templates. When transferred/trained into the positional memory, the training images and the position template name are permanently associated with each other. The positional memory may be a direct or abstract representation of the training image or a set of training images. During a test, test images are compared against the position template or templates that are stored in the positional memory. A positional memory can be used to generate an output response that may consist of the closest match, as identified by the recovered position template name, of the test image(s) to the-set of position templates stored in the positional memory and the level of similarity with that match.

An “associative model”, as used herein, is any type of mathematical algorithm that links or associates input training data to a desired response (for example a position template name, a number, etc.) and that can be used to compare input test data to position templates already stored in the positional memory. The actual comparison model can be direct, such as in a point-by-point comparison of data, or indirect, such as when similarity is judged based on dissimilarity of the test data and the combination of other non-matching position templates stored in the positional memory.

“Buttons,” as used herein, include all conventional means of user input for sending command signals to the device. For example, Buttons may be buttons that a user can physically push to send a command signal, a voice-recognition module, or icons on a monitor that can be clicked on or touched. In addition, Buttons may consist of unconventional means of user input for sending command signals to the device. For example, the very movement and positioning that the device is measuring could become an input or command signal.

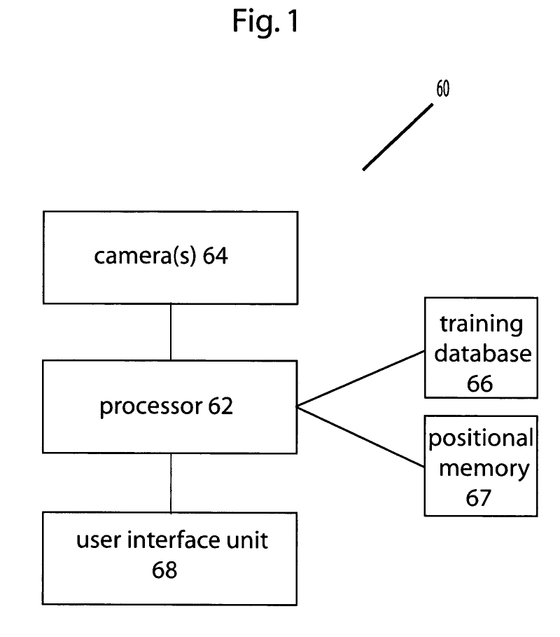

FIG. 1 is a block diagram of a comparison device 60 in accordance with the invention. The comparison device 60 includes a processor 62 that is coupled to at least one camera 64, a training database 66, a positional memory 67, and a user interface unit 68. In both training and testing modes, one or more images are captured with the camera 64, which may be any commercially available camera that can capture images/data repeatedly over time and is deemed to be suitable for the application by a person of ordinary skill in the art.

In the training mode, these images are preliminarily assigned to a position template and stored in a training database 66. The position templates and their associated position template names are then trained/transferred directly or abstractly into the positional memory 67. In the testing mode, the test images are compared to the position templates previously stored in the positional memory 67.

The training database 66 may be implemented as one module and the positional memory 67 as another, although it is not necessary to do so. Depending on the embodiment, the device need not include both training and testing modes. One device may be used exclusively for training, while another separate device may be used exclusively for testing, using the trained positional memory 67. For example, a furniture company could provide a positional memory file and a software program that is used to help the customer properly assemble a new piece of furniture.

Both the training database 66 and the positional memory 67 may be implemented with any conventional storage medium, such as random access memory (RAM) or an optical disk, and the invention is not so limited to any type of storage means. A temporary storage section (e.g., cache memory) for image acquisition and a more long-term storage section for the training database 66 and positional memory 67 may also be implemented. The training database 66 may separately store single or multiple images, each of which may be modified, used individually, and assigned to specific position templates. This way, the comparison device 60 is useful for different users, different targets, and/or different movements. If the targets are human golfers, for example, numerous human golfers will be able to each use the comparison device 60 by storing his or her own training database 66 or positional memory 67 and uploading/activating it as required.

The user interface unit 68 may be any device that is suitable for the type of communication between the user and the processor 62 that is described herein. Preferably, the user interface unit 68 includes both auditory and visual interfaces so that the user may receive feedback or instruction in any of a number of ways: audio, LEDs, images, colors, animations, pre-recorded video, etc. The user interface unit 68 includes an output device for presenting information to the user and an input device for receiving commands from the user.

The comparison device 60 may be designed in many different ways. For example, the user interface unit 68 may be integrated into the camera 64 with either a software or a hardware/button interface to form a compact portable device. This portable device will basically be no more cumbersome than a camera because the entire device, including the processor, is within the camera. In another embodiment, the comparison device 60 may be designed so that the user interface unit 68 and/or the camera 64 transmit data to the processor 62 via wireless protocols.

The comparison device 60 uses the camera 64 to obtain an image of the target in the desired position. The processor 62 stores and assigns the obtained image to a particular position template in the training database 66. Test images can later be compared against these position templates using the positional memory 67. Images of multiple targets and positions may be obtained and stored in the training database 66, each associated with a position template name. In addition, images from more than one position may be associated with an ordered sequence of position templates. By doing so, a series of positions could be analyzed as a single movement. When a user later wants to reproduce the desired position or movement, he accesses a trained positional memory 67 by using the user interface unit 68 to select the testing mode and places the target in a preliminary position. The “preliminary position” usually represents the user's best attempt to duplicate a position template stored in the positional memory 67 without the aid of the comparison device 60. The camera 64 obtains an image of the preliminary position, which then becomes the test image. The processor 62 compares the test image with the position template(s) in the positional memory 67 and provides feedback to the user about how to adjust the test image to match the desired position template. Once the test image and the position template match within a predefined threshold, either the pure response of the positional memory 67 or a threshold-bracketed signal is sent through the user interface unit 68 to let the user know that the desired position/movement has been successfully duplicated.

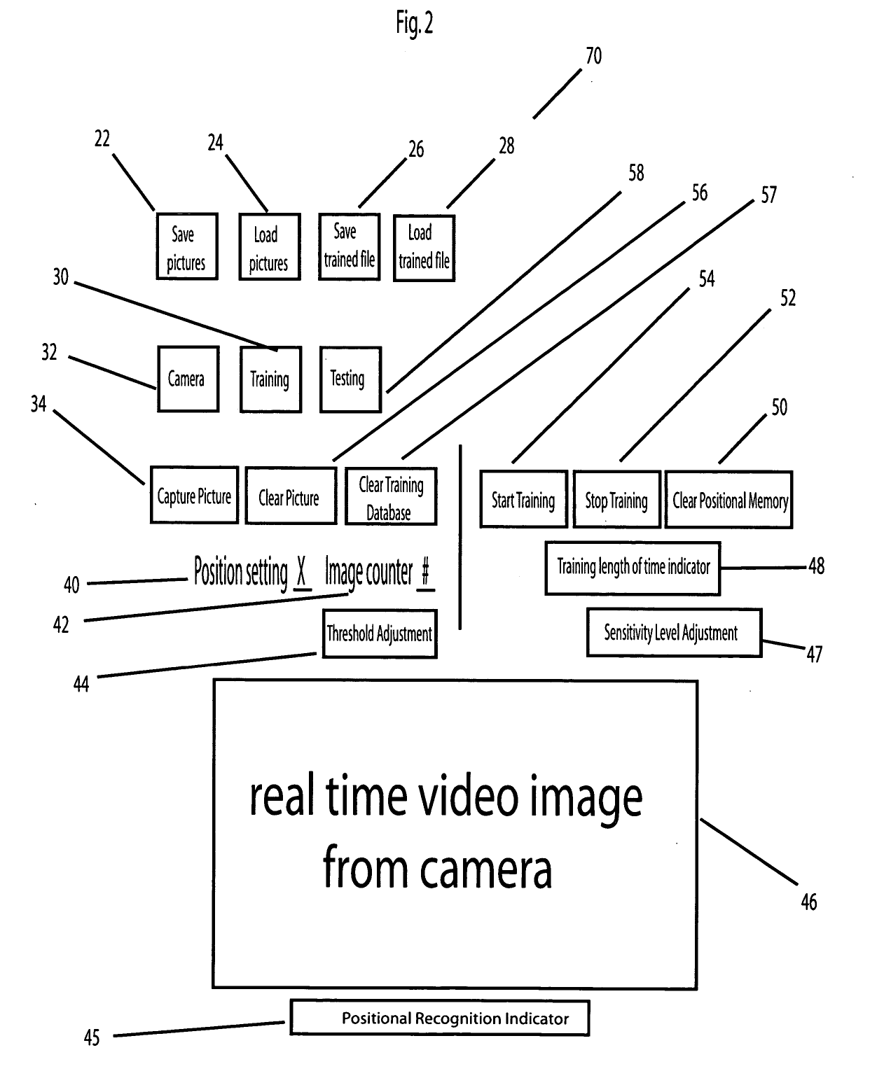

FIG. 2 is a schematic diagram of an exemplary user interface unit 68, shown as a control panel 70. The control panel 70 includes basic system controls that a user may use to send commands to the processor 62.

In this embodiment, Buttons 22 and 24 pertain to operations involving the reading and storage of the training database 66, while Buttons 26 and 28 pertain to operations involving the reading and storage of the positional memory 67. Button 22, if pressed, sends a signal for saving a newly captured, a preexisting, or a revised image set that is in the training database 66 for future access. Button 24 sends a signal for loading an image set into the training database 66 for active use. Button 26, if pressed, sends a signal for saving the positional memory 67 and sensitivity settings for future access/use. Button 28 loads the positional memory 67 and sensitivity settings for active use.

Buttons 32, 30, and 58 are mode-control buttons. Button 32 is a toggle button for turning the camera on/off. Button 30 is used to put the device 60 in the training mode where new images are captured, temporarily assigned to position templates that have temporary position template names associated with them in the training database 66, and subsequently trained into the positional memory 67. Button 58 is used to put the device 60 in the testing mode where test images are compared against position templates using the positional memory 67.

The control panel 70 includes an optional display screen 46 that shows images from the camera 64. When the comparison device 60 is operating in the test mode or the training mode, the display screen 46 displays the image data taken by the camera 64 on a real-time basis. The user, viewing the images on the display screen 46, decides when to capture an image. Buttons 34 and 56 control operations involving the capture of new images. Pushing Button 34 captures the image that is currently displayed on the screen 46 in the training database 66, pushing Button 56 deletes individual captured or selected images from the training database 66, and pushing Button 57 deletes all of the images in (i.e., clears) the training database 66. A position template name identifier 40 shows the position template name or the number assigned to the particular image that is being captured, and a position template counter 42 shows the number of images captured under the position template name identifier 40. For example, if the target is a golfer, the position template name identifier 40 might be “Position 1” or “Full swing—club behind head” or “Full swing—club in mid swing.” The position template counter 42 shows how many images assigned to the position template that is identified in the position template name identifier 40 have been captured and stored in the training database 66.

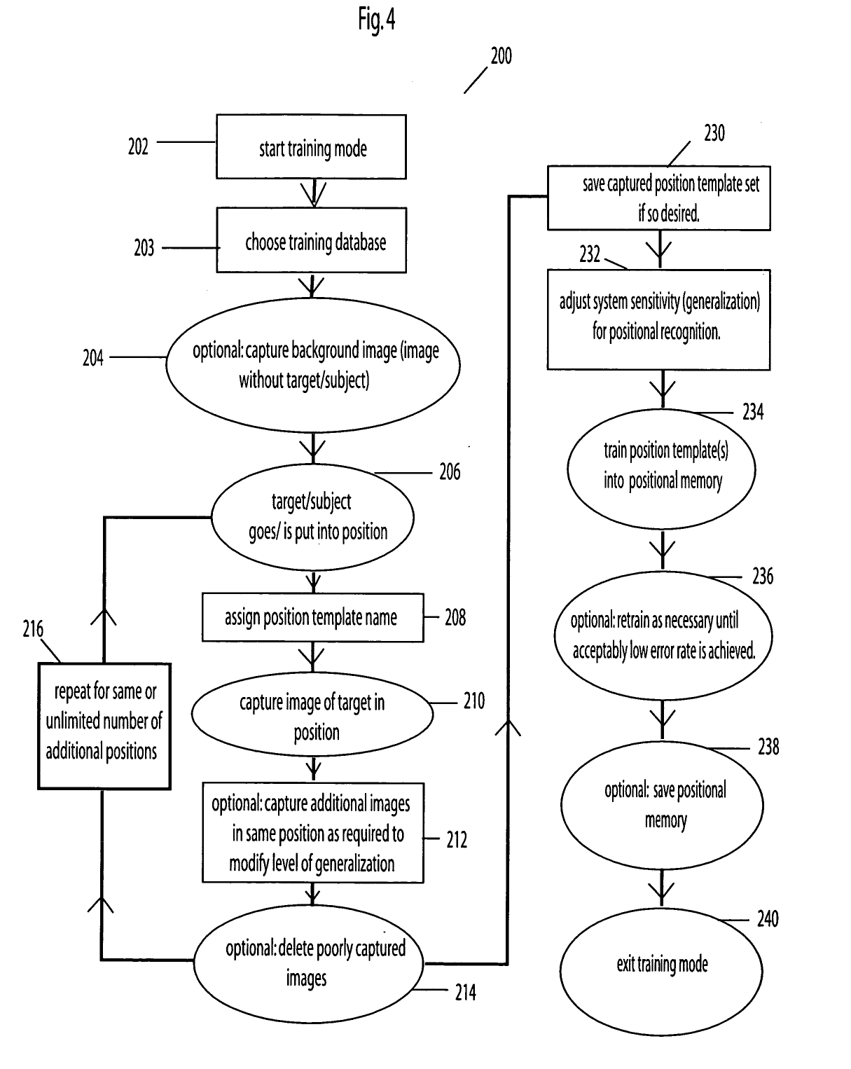

Indicator 48 and Buttons 50, 52, and 54 also may be used when the comparison device 60 is in the training mode. If pressed while the processor 62 is in the training mode, Button 54 initiates the step in the training process in which the positional memory 67 is created, as is depicted in FIG. 4, step 234. Button 52 ends step 234 of the training process. Button 50 clears the positional memory 67. Optional indicator 48 keeps track of the training progress, expressed in terms of elapsed time or completed cycles.

Button 47 allows the user to adjust the sensitivity level or levels, in the case of complex positional memory 67 structures, of the comparisons before a particular training session. Unlike the threshold control 44, the sensitivity control represents the setting of an optional combinatoric preprocessing operation, which is a process of creating higher order inputs from an original image data. This process effectively changes the data using subsets of the same image's data as multiplicative factors. The more times the process is conducted (higher order expansion), the more specific the pattern becomes in relation to others. After several applications of this operation, patterns that might have previously appeared very similar or almost identical become completely different in direct comparison. This setting is an inherent component associated with the construction and use of the positional memory 67, and applies to the data preparation in both the training and testing modes. However, adjustment of the sensitivity control 47 pertains only to the properties of a new positional memory 67 upon creation, either through loading (Button 28) or clearing (Button 50). The value(s) of this sensitivity control 47 may be changed prior to training or creation of a new positional memory 67, but the value(s) of sensitivity control 47 in the testing mode is the same as that which was used in the original creation of the positional memory 67. If more complex positional memory 67 systems are employed that consist of positional memory 67 subsets with varying sensitivity, sensitivity control values obtained from sensitivity control 47 used in the testing mode must also correspond exactly to those used in training.

A positional recognition indicator 45, which is used during testing, indicates the response of the positional memory 67 to an input test image. The positional recognition indicator 45 identifies the position template with the highest similarity to the test data, and the degree of similarity. A position template threshold 44 may be defined in order to bracket the level of similarity required for a match. The operator may choose for example “80%” and/or “60 frames in a row” as the degree of similarity required to identify a position template as a match. The positional recognition indicator 45 may show the position template name, a number, a color, a letter, a picture, an animation, a pop-up window, a multimedia message, etc. indicating the closeness of the match. In its simplest configuration, this output may be a percentage indicating how close the target is to the stored position/movement (where 100% indicates a perfect match, 75% indicates that the images are somewhat matching, etc.). The positional recognition indicator 45 could also be a light indicator and/or a sound alarm that activates when there is a match between the test image and a specific pre-selected position template. In a more complex configuration, additional sound, images, multiple lights, vibrations, etc. may be used to indicate image similarity.

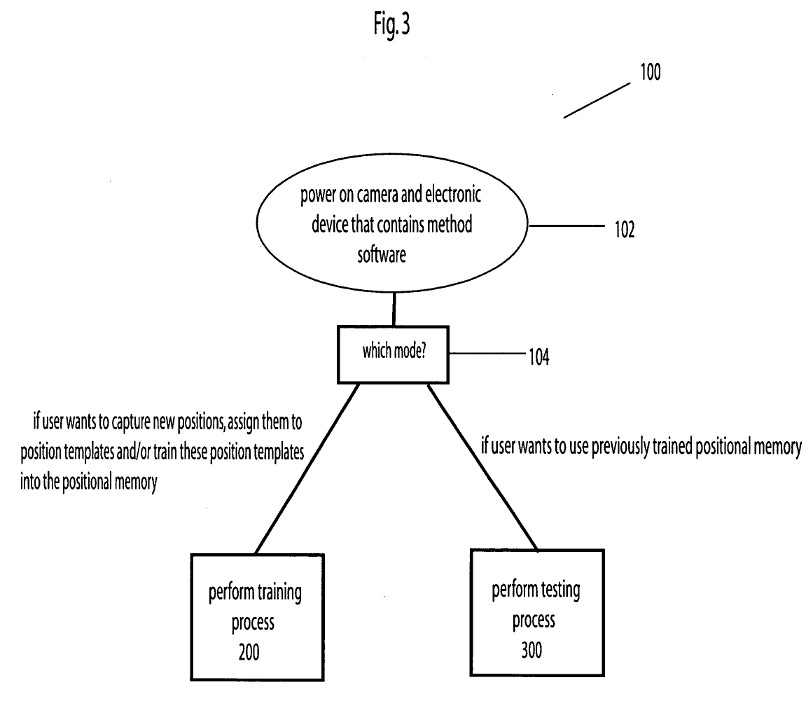

FIGS. 3, 4, and 5 depict the operation of the comparison device 60 in accordance with the invention.

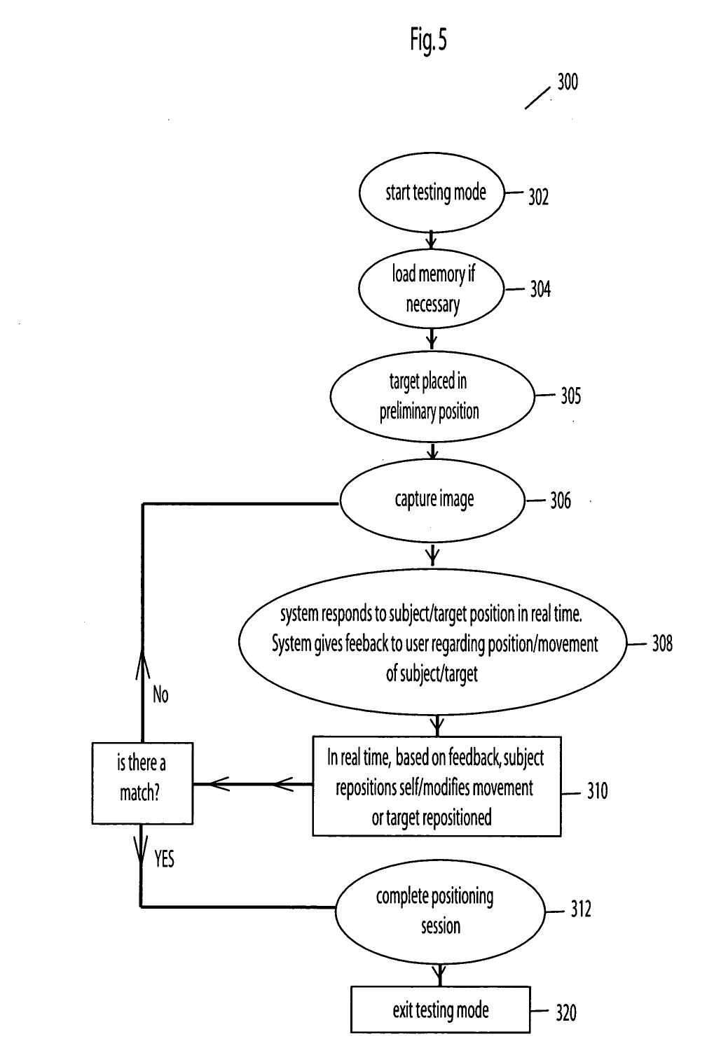

FIG. 3 is a flowchart depicting a mode selection process 100 in accordance with the invention. In response to the camera 64 being powered on (step 102), the processor 62 presents two options to the user (step 104): training mode and testing mode. The training mode allows the user to capture new training images, to preliminarily assign them to position templates in the training database 66, to preliminarily associate position template names to position templates, and then to create and train the positional memory 67 using the training database 66. In creating the positional memory 67, the training images are permanently assigned to their respective position templates and associated position template names. The training process is illustrated in FIG. 4 below (step 200). The testing mode allows the user to compare captured test images against one or more of the stored position templates using the positional memory 67. The testing process is illustrated in FIG. 5 below (step 300).

FIG. 4 is a flowchart depicting the training process 200. “Training” entails capturing and organizing training images from the camera and preliminarily assigning them as well as position template names to position templates in the training database, optionally choosing/modifying the sensitivity level for the soon-to-be-created positional memory 67, and creating a new positional memory 67 via an appropriate associative model. The associative model establishes a permanent link between the training images and their position template names and stores the image, name and linkage data for all the position templates in the positional memory. Depending on the associative model that is used, the data in the positional memory 67 are stored in a direct or abstract manner. Descriptions of several exemplary associative models are provided below.

Upon starting the training process (step 202), the operator can first choose to use previously captured images (e.g., if a part of the training process was previously performed). Referring to the control panel 70 of FIG. 2, the user can train previously captured images by using Button 24 to load the training database 66 as illustrated in FIG. 4 (step 203). If no additional training images are required, the user can proceed to the system sensitivity adjustment step (step 232).

If the user desires to capture additional training images, or if the user is creating a new training database, the user proceeds and the camera optionally captures the background image (step 204). The “background image” includes everything in the camera view except the target(s) and is assigned to its own specific position template name 40, which may be specifically designated in the training database 66. Depending on the embodiment, the user may opt to skip the capturing of the background image because the capturing of the background image is usually an optimization step rather than a step that is necessary for operation. The target then gets into or is placed in a desired position (step 206). The target is positioned at a defined distance from the camera(s). The operator may use a display screen or a viewfinder that displays the camera view to assist in the image capture procedure.

The operator assigns a position template name 40 (e.g., Position C, Position 24, “Full Back Swing”) to an image that is to be captured (step 208). The position template name may be entered by the user through a user interface on the device or may be automatically assigned by the device. Optionally, an ideal position template may be superimposed on the target's display or placed in a secondary display adjacent to the target's display if virtual “coaching” is required. Virtual “coaching” may be supplemented via audio, video, textual, etc information that guides the target into or closer to/towards an ideal position template. In the case of golf, a user may watch a prerecorded video of a golf instructor giving instructions about addressing the ball while the user attempts to fit into an ideal position template. Then, the system captures an image of the target (step 210) using the camera. The image may be captured in response to the operator's command, for example the pressing of Button 34, but is not so limited. Optionally, additional images may be taken of the target in one position (step 212) both for generalizing the position and for fine-tuning the sensitivity response. Multiple, slightly different images taken at a single position or even images taken at completely different positions may be assigned to the same position template. This process allows the system to build up a collection of varying but similar images that correspond to the same position template (namely, the particular position identified by and associated with the position template name listed in 40).

For example, an individual golfer may have minor variations in lighting, clothes, or an arm, elbow or club position between different instances of the position template titled “full back swing.” By acquiring multiple images of the golfer in the “full back swing” position (in a single full back swing position it is likely the body and club will be moving slightly as images are captured; in separate instances of the full back swing position body position is bound to vary slightly), the system will be better able to generate the positional memory that is more inclusive of variations to successfully compare the “full back swing” position template that is stored in the positional memory to the test images. By using Button 34 more than once, the user can capture multiple images of the target in the same position or possibly different positions and associate them with the same position template that is associated with the position template name 40. The operator may also choose to return to this position later and add more images as desired. Referring back to FIG. 2, the image count indicator 42 shows how many images have been captured for the particular position template indicated by 40.

As mentioned before, the user may choose to capture multiple images of a target in an ordered sequence in different positions and associate them with different position template names. The user may create a “movement template,” which includes a series of positions in a predefined sequence that may also include a time interval component. For example, if a golfer captures five images from each of five different positions in the golf swing, and then defines the particular combination of position template names with or without a timing component as “my perfect swing,” the golfer can create a positional memory that can be used for comparisons against a sequence of test images and in real time. By comparing a sequence of test images against such position template data that are stored in the positional memory, the method and device may perform real time movement analysis. More details on the movement template will be provided below.

The captured images may be reviewed, and poorly captured or incorrect images may be deleted (step 214). The user may manually review the captured images (e.g., using the optional display screen 46 of FIG. 2) and instruct the device to delete certain images. Alternatively, a program may be incorporated into the device so that the device automatically deletes or keeps images that meet certain predefined conditions. Steps 206, 208, 210, 212, and 214 are repeated for different positions that have unique position template names associated with them if there are additional positions. This process can be repeated depending on the limitations of hardware and/or the properties of the training database 66, the positional memory 67 and/or the chosen associative model. After all the images in the series are captured, the operator may save the captured set of images as a group (step 230). The operator can stop the training process 200 at any time, for example by pushing a button or clicking on an icon.

If a default value is not predefined, the operator may optionally define the sensitivity level of the training process 200 (step 232) prior to creating the positional memory. This combinatoric preprocessing operation is described in FIG. 2 above.

In the next step, the operator optionally first clears the positional memory using button 50 and then pushes the training button 54 to start the process that creates the positional memory 67 via the establishment of a permanent link between the training images and their respective position template names (step 234). Depending on the associative model chosen for the positional memory, the data in the positional memory are stored in a direct or abstract manner. The particular associative model implemented for storing the images into the positional memory 67 depends on the embodiment chosen and the expected application for which the method and the device will be used. The particular associative model implemented for creating the positional memory 67 is the same model used for generating comparison results in the testing mode, as illustrated in FIG. 5 below. Various associative models including, but not limited to, the following well-known pattern recognition or classification processes may be used both to train the positional memory 67 and to compare it against test images: Euclidean distance techniques, color comparison techniques, neural networks (classifier based systems, back-propagation networks, etc.), the check-sum method, wavelet transforms and elastic bunch graph matching, support vector machines, etc.

Depending on the associative model or system chosen for the embodiment, the operator can retrain the images as many times as he or she wants by pushing the start training button 54 again (step 236) or predefining a number of training “cycles.” For the checksum or simple Euclidean difference pattern recognition methods, a single cycle of training is sufficient for the permanent association of the position template names with the training images, which are then stored in the positional memory. Other associative models that could be used, such as neural network methods, wavelet transform methods, etc., may require additional training cycles and more time for the training process results to converge. If the operator chooses to adjust the sensitivity level, he must reinitialize the positional memory and perform the entire training process again. Indicator 48 shows when the training will stop or has stopped and also indicates the error levels in the training procedure when applicable. For associative models that require more than one training cycle, the user or program terminates the training and records the positional memory 67 (step 238) after reaching an acceptable error level between the desired and actual measured trained values. The user can push Button 50 (FIG. 2) at any time to erase the trained positional memory 67. A detailed description of three exemplary embodiments using three of the aforementioned associative models is found below.

The user exits the training mode by pushing Button 58 or by turning off the camera via Button 32 and then shutting down the user interface and/or the processor 62 (step 240). The training process 200 depicted in FIG. 4 is just one example of how the comparison device 60 may be trained, and the steps of the training process 200 may be adapted to the situation and the application. The training process 200 may be interrupted at any point in time by the user's pressing of a button.

FIG. 5 is a flowchart depicting the testing process 300. In the testing mode, the method and device compare the real time test images input from the camera to the position templates using the positional memory 67. Based on the comparison results, the comparison device 60 can indicate which image is matched and how close the match is by reporting the degree of similarity. The testing process 300 may begin with a user command to begin the testing. In response to the start command (step 302), the target enters a preliminary position (step 305). The camera 64 captures an image of the target (step 306) to form a test image.

The processor 62 uses the positional memory 67 to compare the test image taken in step 306 against the position templates (stored in the positional memory 67) to obtain a comparison result and to provide feedback to the user using the comparison results (step 308). Comparison results are obtained using an associative model, as described above. The associative model implemented in the training procedure is substantially the same as the model used for generating comparison results.

The training and storage method chosen depends on the particular application employing this device.

The comparison result provides feedback that informs the user that the target should be moved to match the position template(s) stored in the positional memory. In one potential “coaching” embodiment, the comparison result may include a view (e.g., an outline) of the ideal position template or a generic or standardized position template superimposed on or placed adjacent to the test image taken in step 306. A user who sees the superimposed images can adjust the target position so that it is closer to the position template (step 310). Other “coaching embodiments” can be envisioned that use live or prerecorded audio, video or other types of data feeds both to provide feedback to the user and to help the user adjust the target position so it matches or lines up better with the position template. As the user moves to adjust his position, the comparison device continuously, at a predetermined time interval (e.g., every second), checks to see how close the user's position matches one of the positional templates stored in the positional memory. The comparison device is also capable of providing continuous feedback to the user, for example at the same time interval the comparison is made. The feedback may include showing a percentage of match between the user's current position and the position template(s) stored in the positional memory. This percentage changes as the user moves.

The device may provide a visual, auditory, or other type of signal to the user when the position of the test image falls within the pre-defined threshold 44 (i.e., there is a match). If the comparison result indicates that the difference between the position template and the test image is within the predetermined threshold, the positioning session is effectively complete (step 312). However, the target can continue to use the feedback of the system to improve the position. After the testing session is complete, the operator can exit the testing mode (step 320) either to initiate a new training session by pushing the training button 30, or by turning off the camera via button 32 and then exiting the interface. It may not always be necessary to turn off the camera or exit the interface to exit the testing mode.

In the testing process 300, the target can enter/be placed into the camera's field of view either prior to or after initiating the testing procedure in step 302. The positional recognition indicator 45 (FIG. 2) will indicate that a match is detected when the test image has an acceptable degree of similarity with one of the position templates stored in the positional memory 67. Where multiple position templates are stored, the processor 62 recognizes the different position templates. In this case, the positional recognition indicator 45 will display both the position template name (as defined during training by position template name 40) and how similar the target in the test image is to the position template that is trained into the positional memory (via a percentage value, a color, etc. for example). The target may need to reposition/be repositioned any number of times (step 31 0) before properly matching a stored position template.

The testing process 300 may be continuously performed using multiple position templates. For example, a user may try to match Position A, then manually load or train Position B into the positional memory (in step 304) when he feels like moving on to the next position. Alternatively, if more than one position template has already been trained into the positional memory, the comparison device 60 may automatically determine which position template, if any, most closely matches the position the target is in so that no manual loading of different position templates is necessary. For example, if a user is addressing a golf ball, the comparison device 60 initially automatically detects that his position is closest to the positional memory titled “address the ball,” and provides feedback as to how close the user's current position is to the “address the ball” position template that is stored in the positional memory. In response to the feedback, the user adjusts his position until there is a sufficiently close match. Then, when the user starts his backswing, the comparison device 60 automatically detects that his position is now closer to the “back swing” position template than to the positional position template “address the ball” and starts to compare the test images against the “back swing” position template. Both the “back swing” position template and the “address the ball” position template would be stored in the positional memory. If the user goes back to addressing the ball, the comparison device will automatically revert to comparing the test images against the “address the ball” position template that is stored in the positional memory.

In an alternative embodiment, the testing process 300 may be set up so that a target recognition of a “match” functions as a trigger or input to the processor 62 that initiates or completes a process. For example, in the above example of a golfer, the processor 62 may automatically move on to the “back swing” position template that is stored in the positional memory once the test position matches the “address the ball” template with a predefined degree of accuracy. A feedback would be provided, for example in the form of a beeping sound, the playback of a new video or multimedia coaching segment, etc. to let the user know to move on to the next position. In some embodiments, a “match” automatically ends the testing mode.

As mentioned above, there are different associative models that may be used to train the positional memory. Situations where sounds or objects and environmental conditions are well-defined may employ a simple difference method of pattern recognition, one version of which is known as “minimizing the Euclidean distance”, where data point intensities from the test image are compared directly against training data set by subtraction. Identical or nearly identical data points will cancel, giving resultant values near zero. In this method, to facilitate direct comparisons, the test image(s) are combinatorially preprocessed, if necessary, in the same way the position templates are preprocessed during the training/transfer procedure into the positional memory. For optimization of training and comparison speed, especially when using more than one position template, each of which may have more than one training image associated with it, the user may implement a stepping function that selects portions but not all of the recorded data. Incorporation of this function decreases the number of data points that need to be trained and compared to accurately determine a match between the test image and the positional memory, decreasing the testing time with some corresponding but controllable loss of resolution. Also, instead of using original data for training and comparisons, data can be converted to alternate representations (for example, RGB (red, green, blue) data expressed as HSI (hue, saturation, intensity) data in a video example) prior to training and comparison to enhance both recognition speed and efficiency.

Simple difference methods can potentially provide more quantitative precision at the cost of higher processing requirements. Neural network systems, in comparison, can potentially offer greater generalization characteristics or reaction times during the testing phase (in FIG. 5) at the cost of longer training times or training processing requirements (in FIG. 4). Other methods such as the checksum method, which is basically a comparison of the total sum of all the data in two patterns, or wavelet transform methods, among others, can also be envisioned as viable variants for the training and memory component of the overall method and device described herein. The process most appropriate for the particular application of the method and the device may also employ a wide array of image processing techniques, such as edge detection, prior to application of any of these associative models. Preferably, an embodiment depends primarily on the conditions existing at the deployment location and the desired operating characteristics.

Below are three exemplary embodiments of the training and testing procedures associated with the device and the method. Each uses a different associative model.

### EXAMPLE 1

In the simplest case, one set of test image data could be directly subtracted pointwise (or calculating the Euclidean distance) from the position templates stored in the positional memory. In the training procedure illustrated in FIG. 4 (step 200), the first position would be assigned a position template name that would be preliminarily associated with a position template (step 208), and then images would be captured (step 210) and stored in a training database 66. Additional position templates could be assigned and images could be captured, if necessary. The user would then have the option of adjusting the system sensitivity in step 232. In this case, the permanent linking of the position template name to the position template data itself in would constitute the “training” of the positional memory (step 234), and this process could be repeated for as many position templates as desired. In the “testing” mode, illustrated in FIG. 5 (step 300), if the total sum of all of the differences of directly corresponding data point values in the image is below a pre-defined threshold, meaning that the two data sets are significantly similar, then that would constitute a ‘match’ condition (step 308). Different stored positions would give different match response results, where a perfect match would occur if all points were exactly the same as the training set. Dissimilar test images would not give a low-value total sum result, and could be disregarded. Despite its simplicity, there are high precision applications where this system would be the most efficient.

### EXAMPLE 2

In another example, the position templates could be linked to responses using standard neural network training algorithms (back propagation, boosting classifiers, etc.). In the training procedure illustrated in FIG. 4 (Step 200), the first position would be assigned a position template name that would be preliminarily associated with a position template (step 208), and then images would be captured (step 210) and stored in a training database 66. Additional position templates could be assigned and images could be captured, if necessary. After adjusting system sensitivity, if so desired, in step 232, the user would train the neural network on this set of position templates over multiple epochs (steps 234, 236). A positional memory would be built with some level of generalization capabilities. Ideally, it would give a similar response for all position templates trained or assigned to the same response, and different, specified values for the other position templates. In the “testing” mode as illustrated in FIG. 5 (step 300), untrained test images that have a pre-defined level of similarity to the original position template data, as defined by the positional memory itself and the particular algorithm chosen, would generate a ‘match’ condition (Step 308), whereas test images significantly dissimilar to the trained position templates would create no substantial response. Unlike the simple subtraction method, which is essentially a comparative database, the neural network would be a single collective unit that takes the input and makes a decision over a range of possible outcomes, with some weight signifying the confidence associated with the final decision. The potentially much smaller memory size and generalization characteristics lead to lower storage requirements, more robustness, and faster reaction times.

### EXAMPLE 3

Yet another alternative might be a system similar to the simple point-subtraction technique, but using wavelet transforms (for example, the Gabor filter) to convert the control and test image data to another, reduced representation that could be used to conduct the similarity comparison. In the training procedure illustrated in FIG. 4 (step 200), the first position would be assigned a position template name that would be preliminarily associated with a position template (step 208), and then images would be captured (step 210) and stored in a training database 66. Additional position templates could be assigned and images could be captured, if necessary. The user would then have the option of adjusting the system sensitivity in step 232. For training in this case, the reduced form of the position template would be assigned or linked permanently to the desired position template name (Step 234). Multiple reduced position template sets assigned the same response could either be maintained separately (with the same training value) or mathematically averaged in the new representation and then linked as a single, combined unit to the desired response. In testing (step 300), only test images that have a high correlation to position templates recorded in this type of reduced-state positional memory would be considered a viable ‘match’ (step 308). This type of model would be most efficient in cases where precise locations of points in images need to be identified, but the inter-image location distances may vary, as in the location of eyes and mouth for different people's faces.

The different types of associative models discussed above each has its strengths and weaknesses. The method and device of the invention are by no means limited to any one of these associative models and each of the above-mentioned associative models would function within the overall framework of the invention. In fact, any technique that can effectively differentiate two or possibly more pattern sets, effectively delineating what is and what is not a learned pattern, would fit within the bounds of the positional memory associative model description of the method and device described herein.

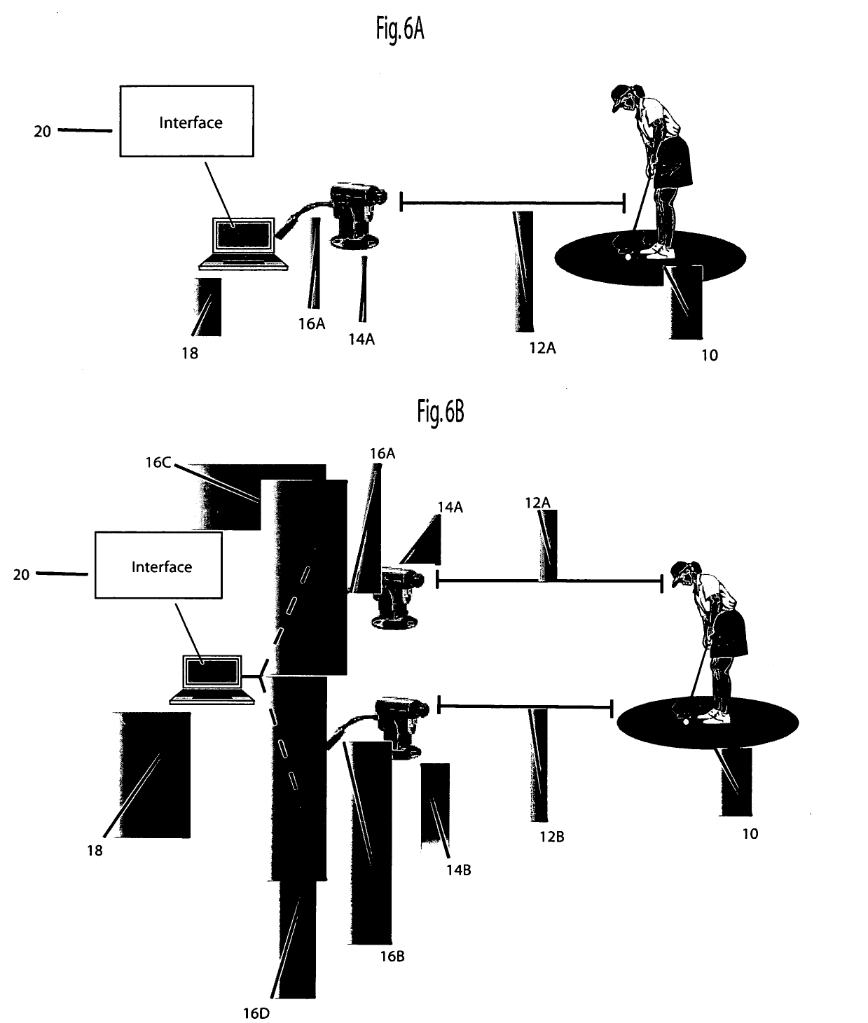

FIG. 6A is an exemplary embodiment of the invention. The particular embodiment performs a two-dimensional or three-dimensional real time image comparison using two-dimensional spatial data as the input. A target 10 (the target 10 can be either animate or inanimate, depending on the end use goal for the method) is located a predefined distance 12A from a camera 14A. A cable 16A is an off-the-shelf cable capable of transmitting video data, and links the camera 14A to an electronic device 18. The particular embodiment uses commercially available computer 18 including a micro processor/microcontroller and a memory. The computer 18 may be a palmtop computer, a laptop computer, a desktop computer, or a microprocessor/microcontroller that is embedded directly into a camera or a similar stand-alone device. The computer 18 stores the images acquired during the training process of FIG. 4 and compares this data stored in the positional memory to incoming real-time data from the camera 14A during the testing process of FIG. 5. A user interface 20 is connected to the computer 18. Through user interface 20, the user communicates with the computer 18.

FIG. 6B is another exemplary embodiment of the invention. The embodiment of FIG. 6B is a variation of the embodiment described in FIG. 6A. Unlike the embodiment of FIG. 6A, this embodiment includes multiple cameras: a first camera 14A and a second camera 14B. The second camera 14B is connected to computer 18 via a second cable 16B, which is identical to the first cable 16A. Additional identical cables 16C and 16D (others as well) may be connected to additional cameras (not shown).

In this embodiment, several cameras are used to construct a three-dimensional positional/movement recognition method. The computer 18 is programmed with a way of putting the images from the several cameras together to conduct a three-dimensional analysis during the testing process. Images from multiple video cameras can be stored and compared separately or in a composite fashion, depending on the embodiment and the application.

### Alternative Embodiments

The invention may include a piece of material to which a camera or cameras are temporarily or permanently fixed. This piece of material may also contain an indicator showing where the target should be placed for optimal positional recognition/training. For example, by attaching the camera to the edge of a mat/artificial golfing green, the user may receive swing training from an instructor who uses the method for storing a student's accurate golf swing positions. Later, the student can use the method for testing and practice, knowing full well that the student's distance from the camera is equal to the distance that the student was at during the instructor-mediated training procedure.

The invention may also include a timing component which can be used to determine how much time it takes a target to assume a defined position. In the multiple-position case, the time component allows for the comparison of movements. With this movement-comparison embodiment, the target has to pass through a series of positions within a defined transition period. As the method can easily include a digital time counter, this embodiment can be used, for example, in a game to see how fast a set of targets can be put into a particular position/set of positions. In a sports-training example, it can be used to specify the speed at which a practice swing should be performed. The appropriate speed may be defined externally or may be determined during the training phase when the position templates are first defined. By doing so, it becomes possible to test how quickly a target can move between positions and then to compare that time to some sort of standard or baseline time.

In some embodiments, a defined sequence of positions may be assigned to position templates that together form an effective “movement template.” In these embodiments, as the target moves through a sequence of predefined positions the invention may recognize the individual positions that make up that sequence. If the method and device fails to recognize a part of that sequence (for example, if recognition drops from 100% to 50% at the point in the golf swing where a golfer makes contact with a ball but is at 100% for every other part of the swing), then the target will know what part of his swing could benefit from improvement. Alternatively, a nearly identical series of positions that make up a movement could be assigned to two different movement templates. Perhaps the only difference between the two position templates would be the last position. In the case of golf, perhaps for the last training image of the first movement template, the golfer purposefully overextends his follow-through. In the last training image of the second template, the golfer purposefully underextends his follow-through. After training these position templates into the positional memory and recording the sequences in the movement template, the invention will now be able to differentiate between two nearly identical swings that vary only in their follow-throughs. One swing could be called “overextended swing” and the other could be called “underextended swing.”

In another embodiment, various, uniquely different positions may be trained with the same position template name, effectively defining a range of motion, and may be regarded as a “range position template”. The range position template, unlike the movement template, would define a multi-dimensional space of allowed positions or movement, with no sequence or timing dependencies. This type of embodiment would be useful for applications where portions of the image may change, as in a head movement with the rest of the body aligned, or where information about the range is desired but the actual positions within that range can vary widely. For example, if a mother were concerned that her baby might fall out of a high chair when she was not with the baby, she might assign training images of the baby in a variety of positions in the highchair to a range position template. The range position template would define where she wants the baby to be. After completing the training process and initiating testing, the invention could provide feedback to the mother as to whether or not the baby is in the highchair. While the baby sits in the chair, going through his normal range of positions and movements, the invention would indicate that the baby is in the chair. If, however, the baby were to fall out of the chair, it could send feedback, perhaps in the form of a warning message, to the mother.

The invention may also be configured to perform the role of a watchful eye during the assembly or construction of various items. If a target requires ten distinct steps for proper assembly, the shape of the target after each of the steps can be stored by this method. When a camera is placed in an appropriate position so as to observe the assembly process, the system can indicate when a step has been performed properly. The invention may also function as a watchful eye for security purposes. The invention could learn a certain position that may consist of a door being closed or open, a parking space being empty or filled, etc. The invention could then, when attached to a communications mechanism, report to an appropriate authority that a specific situation has changed. Although on the surface such a function may seem to be standard motion detection, by applying the concepts outlined in the next paragraph (namely breaking up the training image into smaller and user-defined subimages), the invention may keep track of the positions and/or movements of a number of individual targets simultaneously.

More complex embodiments of this method are also possible. In one complex embodiment, different parts of a target are stored separately in the training database. For example, for a golfer, images of the head, elbow and hips may be stored separately in the database. Each stored image is a component sub-training image of the original training image. The component sub-training images become the training images, or “inputs” for sub-positional memories. A “sub-positional memory” is defined as a single unit of a positional memory, where the positional memory is formed from an array of separate associative model components. Each sub-positional memory may have a variety of independent characteristics that are associated with it. These characteristics include design characteristics, where design characteristics refers to but are not limited to image size (an sub-image of the hips may be larger than a sub-image of an elbow), and operating characteristics such as sensitivity, threshold values, etc. The sub-positional memories act independently but may be interpreted as different sections of the same position template. The sub-positional memories can be used to differentiate between individual position template sections, or “sub-position templates”, across the complete set of position templates trained in the (overall) positional memory. The sub-positional memories may be trained together in combination as a single positional memory. In this more complex embodiment, during the testing procedure, part of the target may be positioned correctly while other parts may be out of position. By having the method signal to the user/operator/control system that for example the head is in position but the left elbow is not, the method assists the user/operator/control system to fine tune positioning/movement. In this type of case for example, the user interface could show an image of the head as being blue but the left elbow as being red in color. The red will signify that the body part in red (the elbow) is out of position.

An additional complex embodiment can be envisioned. A “complex positional memory structure” would be a memory that is formed from layers or combinations of independently acting associative models. The combination of the independent memory units would form a complete memory, and would result in a single discernible classification result for any input test image. If desired or necessary, the independent memory units may also be interconnected in various arrangements, including serial, parallel, feedback (where the output of one unit is used as input to itself or other memory units), etc., or combinations thereof.

In still another embodiment, one training image of a target in a specific position could be associated with one position template name while another training image of a target in a different specific position could be associated with a second position template name. The training images and their associated position template names could then be trained into the positional memory. During the testing phase, the test image could be divided into “sub-test images” and compared simultaneously or sequentially to the positional memory. If the target is in a position that is a combination of the two positions trained into the positional memory, the invention would be able to indicate to the user that the target position is a combination of the first position and the second position. In other words, the invention would be providing feedback regarding multiple positions at the same time from the same test image. For example, a golfer or dancer may change between two positions which involve a full 90 degree rotation of the body. If the rotation is only half completed, for example if the top half of the body rotates but the lower half of the body does not, the device in this configuration would be able to discern that the upper half of the body is in the second position, while the lower half of the body is still in the first position. In this way the target would know that the rotation would need to be completed in the lower half of the body to fully match the second position.

In still another embodiment, a single training image could be divided into sub-training images and these sub-training images could be associated with different position template names. During the testing phase, a single test image could be compared simultaneously against these position templates, the combination of which would match the size of the test image. By doing so, the invention could differentiate sub-positions within the testing image where a “sub-position” is defined as a specific sub-section of the testing image or a specific-subsection of the target. In other words, each sub-position of the testing image could be identified independently of the overall training image or images that were originally used to train the positional memory. For example, a training image of a teddy bear sitting on a bed could be trained into the positional memory in such a way that the sub-training image that includes only the teddy bear is associated with one position template name and the rest of the image is associated with a different position template name. If the teddy bear is then moved to a chair and is in substantially the same position and a testing image is captured of the teddy bear in this new environment, the positional memory will be able to provide feedback as to whether or not the teddy bear is in the same position that it was in when it was on the bed in spite of the fact that the rest of the testing image does not agree with the original training image. In other words, the teddy bear's position becomes independent of its training environment.

Another embodiment involves the use of image processing techniques to modify the captured images prior to any training or testing. Image processing extends the range of applications indefinitely. Processing functions such as grayscale, edge detection, Fourier transform filters, etc, can all be used as part of the general method.

Yet another embodiment relates to the nature of the sensors. In this example, the sensor is an off the shelf video camera. Other sensors, and not just visual sensors, can be used as well. First off, both analog and digital sensors can be used. If an analog sensor is used an analog-to-digital converter will be included in the system. Microphone(s), X-ray machines, Infrared cameras, radar, thermometers, etc. can all be used with the method to ascertain, confirm, reconfirm and assist in finding positions. Sensors or groups of sensors capable of continuously measuring signals over time can be used. For example, the system can be configured to capture sounds in time from different locations, and learn those spatio-temporal sound patterns to assist in positional recovery, etc. For example, an operator could train the system on a sound “profile” consisting of any number of speakers in defined locations. Later, the operator could use the system to find the original speaker locations based on the “audio” position templates that are stored in the positional memory.

Advantages

The invention provides a simple procedure for creating a record of the location of targets/groups of targets in 3-dimensional space. The invention provides assistance/feedback for repositioning the target(s) at a later time and in their original positions. The invention allows for the repositioning of one target relative to other object(s) as well as for absolute positioning of a target/group of targets. For example, the invention can be used in an art class to ensure that the target(s)/subject(s)/model(s) maintain a consistent position/pose from art session to art session. Where a film crew regularly sets up the same set at different times or in different locations, this invention will assist the crew in accurately recreating the set. Also, if a parent wants to observe a child to confirm that the child does not move (perhaps a punished child must sit in the corner of a room), the parent can use this method to confirm that the child does not move by using the invention as a motion detection application. Also, if a computer user wants to be reminded not to slouch in his or her chair while using the computer, this method can be used to help the user maintain a healthy sitting position or other ergonomically favorable positions.

The invention also provides a simple procedure for creating a record of the movement of a target/targets through 3-dimensional space. The invention then provides assistance/feedback for repeating the movement accurately. In an exemplary application, the invention can be used by an instructor to help a student improve an action, such as a golf swing. The method can be used to remember an appropriate swing (defined by this method as a sequence of distinct positions), as determined by the instructor. At a later time, the student can practice the swing using the method to improve swing performance or ensure swing fidelity. The invention can be used in conjunction with audio video, textual or other training materials as a way for users or targets to train themselves in applications and exercises that require 3-dimensional positioning.

This invention can be used in conjunction with a locking mechanism to create an unlock “key” based on a particular sequence of gestures or movements.

An advantage of the invention is that this method does not require that sensors of any kind be attached to the subject/target for the positional recognition/movement recognition activity to function successfully. For the movement recognition application in particular, this method allows the subject to practice the movement as it would in real life, without any additional equipment that could potentially cause the movement during training to differ from the same movement in the “real world”.

Furthermore, this invention does not rely on cumbersome equipment for the method to acquire positional/movement data. In its simplest embodiment, the method requires an off-the-shelf computing/processing device (processor 62) and an off-the-shelf analog or digital spatial data sensor/device (camera 64). These may include, but are not limited to, video cameras, microphones, X-ray machines, infrared (IR) cameras, thermometers, etc. It is even possible to combine the processing and capture device(s) into one simple, mobile device.

The invention offers the capability of altering the tolerances/thresholds for acceptable positions and movements using threshold adjustment 44 and sensitivity level adjustment 47, thereby creating a type of “generalization” that offers flexibility for the user to determine how much accuracy is required for the positioning/movement activities with which this present invention is related. In addition, similar positions can be linked to the same response. Or, different positions also can be linked to the same response. These features further enhance the generalization capability.

Depending on the storage algorithm chosen, the positional memory 67 is able to compress image information in some embodiments thereby requiring only limited storage space. With this, it is possible to create a portable, low cost device that requires only limited memory capacity.

The device of the invention can be made so that the system analyzes and reports positional information in real-time.

Preferably, the processor is sufficiently high performance such that training procedure is fast. This way, the testing procedure will also be fast and, depending on the embodiment, can be conducted at the frame rate of the camera chosen.

There is a built-in flexibility to the invention because the operator can determine an acceptable error level.

More than one camera can be used simultaneously to create varying qualities of three-dimensional images.

Although preferred embodiments of the present invention have been described in detail herein above, it should be clearly understood that many variations and/or modifications of the basic inventive concepts herein taught which may appear to those skilled in the present art will still fall within the spirit and scope of the present invention.

What is claimed is:

1. A method of comparing a positional memory to a test image, the method comprising:
obtaining training images of a target in one or more positions;
assigning the training images to a position template;
generating a positional memory that takes into account variations among the training images that are assigned to the position template;
obtaining a test image of the target in a current position;
comparing the test image against the positional memory to generate a comparison result; and
providing a feedback regarding the comparison result while the target is substantially in the current position.

2. The method of claim 1, wherein at least one of the generating and the comparing comprises using an associative model.

3. The method of claim 2, wherein the training images and the test image are modified with an image processing technique prior to application of the associative model.

4. The method of claim 1, wherein the comparison result comprises an indicator indicating a degree of match between one of the test images and the positional memory.

5. The method of claim 4 further comprising generating an alert if the level of resemblance between one of the test images and the positional memory is within a predefined range.

6. The method of claim 4 further comprising adjusting the predefined range in response to a user input.

7. The method of claim 1, wherein the comparison result indicates how the current position of the target is to be adjusted to become more similar to the position template stored in the positional memory.

8. The method of claim 1, wherein the target is assisted via one or more of audio, video, and textual information in assuming a position that is captured as a training image.

9. The method of claim 1, wherein the target is assisted via one or more of audio, video, and textual information in adjusting the current position to better match a position template stored in the positional memory.

10. The method of claim 1, wherein generating the positional memory comprises storing the position template in a training database that contains the training images and a position template name associated with the position template.

11. The method of claim 10, wherein generating the positional memory further comprises selecting a subset of the training images from the training database to permanently associate with the position template name when generating the positional memory.

12. The method of claim 10, wherein the training database contains background data that is associated with and extracted from the position template before or during the creation of the positional memory.

13. The method of claim 1, wherein there are a plurality of position templates, further comprising:
identifying a particular position template stored in the positional memory that most closely matches the test image as the target moves from a first test position to a second test position; and
comparing the test image against the particular position template such that the target's position is compared against different position templates at different points in time.

14. The method of claim 13, wherein the test image is compared against the plurality of position templates serially.

15. The method of claim 13, wherein the test image is compared against the plurality of position templates simultaneously.

16. The method of claim 13 further comprising:
determining a transition period for the target to move between a first test position that is recognized as corresponding to a first position template and a second test position that is recognized as corresponding to a second position template, wherein the first position template and the second position template are stored in the positional memory; and
comparing the transition period to a predefined time period that is associated with the target's movement from the first position template to the second position template.

17. The method of claim 16 further comprising indicating a match if the transition period and the predefined time period are within a predefined range of each other.

18. The method of claim 13 further comprising determining whether a target has moved through a pre-defined sequence of positions that are recognized as corresponding to a predefined sequence of position templates stored in the positional memory.

19. The method of claim 18 further compromising using a digital timer to measure the time it takes the target to move through the predefined sequence of positions.

20. The method of claim 19 further comprising comparing the measured time period to a predefined time period.

21. The method of claim 20 further comprising indicating a match if the measured time period and the predefined time period are within a predefined range of each other.

22. The method of claim 1, wherein the position template is associated with training images that are taken with the target in more than one position, wherein the training images form a range of positions that generates an identical position template name response on comparison to the positional memory.

23. The method of claim 1, wherein the comparison result functions as an input to the processor to initiate, continue, or conclude a process.

24. The method of claim 1, wherein there are a plurality of positional memories generated based on a plurality of position templates, further comprising selecting a positional memory that is most similar to the test image before the comparing, wherein the comparing is done using the selected positional memory.

25. The method of claim 1, wherein the position template, the positional memory, and the test image comprise an analog data recording of a digitizable sensor signal.

26. The method of claim 1, wherein the position template, the positional memory, and the test image comprise a digital data recording of a digitizable sensor signal.

27. The method of claim 1 further comprising:
subdividing each of the training images into component sub-training images;
associating the sub-training images to a position template name and storing the component sub-training images and the associated position template name in the training database;
transferring each of the component sub-training images into the positional memory; and
analyzing the component sub-training images simultaneously to offer a more specific feedback.

28. The method of claim 1 further comprising adjusting a sensitivity level of the positional memory using higher order expansions on the training data before the generating of the positional memory.

29. The method of claim 1, wherein generating the positional memory comprises:
combining multiple sub-memories with varying individual designs, operating characteristics, and inputs to produce a combined result; and
interpreting the combined result to make a viable comparative assessment of the position template that is stored in the positional memory and test images.

30. The method of claim 29 wherein the sub-memories may utilize signal feedback in the generation of a classification result.

31. A device for comparing a positional memory to a test image, the device comprising:
an imaging device for obtaining training images of a target in one or more positions and a test image of the target in a current position; and
a processor for:
assigning the training images to a position template;
generating a positional memory that takes into account variations among the training images that are assigned to the position template; and
comparing one of the test images against the positional memory to generate a comparison result; and
a user interface unit for providing a feedback regarding the comparison result while the target is substantially in the current position.

32. The device of claim 31 further comprising a training database for storing the training images and the associated position template names.

33. The device of claim 31, wherein the processor determines a degree of match between the test image and the positional memory.

34. The device of claim 31, wherein the user interface unit comprises one or more of:
a graphical display, a speaker, and a vibrating output device.

35. The device of claim 31, wherein the imaging device is one of a visual sensor, camera, X-ray machine, and a radar machine.

36. The device of claim 31, wherein the imaging device is a device capable of providing reproducible digitizeable data.

37. The device of claim 31 further comprising a digital counter that measures a transition time between when the device recognizes the target in a first position and when the device recognizes a target in a second position.

38. The device of claim 31, wherein the imaging device is a first imaging device, further comprising a second imaging device positioned to obtain an image of the target from a different angle than the first imaging device.

39. A computer-readable medium having computer executable instructions thereon for a method of comparing a positional memory to a test image, the method comprising:
obtaining training images of a target in one or more positions;
assigning the training images to a position template;
generating a positional memory that takes into account variations among the training images that are assigned to the position template;
obtaining a test image of the target in a current position;
comparing the test image against the positional memory to generate a comparison result; and
providing a feedback regarding the comparison result while the target is substantially in the current position.

40. The computer-readable medium of claim 39, wherein the comprises using an associative model for at least one of the generating and the comparing.

41. The computer-readable medium of claim 39, wherein there are a plurality of position templates and the method further comprises:
identifying a particular position template stored in the positional memory that most closely matches the test image as the target moves from a first test position to a second test position; and
comparing the test image against the particular position template such that the target's position is compared against different position templates at different points in time.

42. The computer-readable medium of claim 41, wherein the method further comprises:
determining a transition period for the target to move between a first test position that is recognized as corresponding to a first position template and a second test position that is recognized as corresponding to a second position template, wherein the first position template and the second position template are stored in the positional memory; and
comparing the transition period to a predefined time period that is associated with the target's movement from the first position template to the second position template.

43. The computer-readable medium of claim 42, wherein the method further comprises indicating a match if the transition period and the predefined time period are within a predefined range of each other.

44. The computer-readable medium of claim 41, wherein the method further comprises determining whether a target has moved through a pre-defined sequence of positions that are recognized as corresponding to a predefined sequence of position templates stored in the positional memory.

45. The computer-readable medium of claim 39, wherein the comparison result functions as an input to the processor to initiate, continue, or conclude a process.

46. The computer-readable medium of claim 39, wherein there are a plurality of positional memories generated based on a plurality of position templates, and wherein the method further comprises selecting a positional memory that is most similar to the test image before the comparing, wherein the comparing is done using the selected positional memory.

47. The computer-readable medium of claim 39, wherein the method further comprises:
subdividing each of the training images into component sub-training images;
associating the sub-training images to a position template name with each of the component sub-training images and storing the component sub-images and the associated position template names in the training database;
transferring each of the component sub-training images into the positional memory; and
analyzing the component sub-training images simultaneously to offer a more specific feedback.
